(19) United States
(12) Patent Application Publication
(10) Pub. No.: US 2020/0128847 A1
(43) Pub. Date: Apr. 30, 2020

(54) EDIBLE WATER-BASED FOOD GRADE ADHESIVE

(71) Applicant: Rich Products Corporation, Buffalo, NY (US)

(72) Inventors: Krishna Kumar, Buffalo, NY (US); Rochelle DeLoach, Buffalo, NY (US); Brian Rudyk, Buffalo, NY (US); Brooks Davidson, Buffalo, NY (US); Sachin Bhatia, Buffalo, NY (US); Lori Keith, Buffalo, NY (US); Samantha Milota, Buffalo, NY (US)

(21) Appl. No.: 16/667,166

(22) Filed: Oct. 29, 2019

Related U.S. Application Data
(60) Provisional application No. 62/751,889, filed on Oct. 29, 2018.

(51) Int. Cl. A23G 3/34; A23L 33/105; A23L 29/262; A23L 29/212

(52) U.S. Cl. CPC A23G 3/343; A23L 33/105; A23V 2002/00; A23L 29/212; A23L 29/262

(57) ABSTRACT

An edible water-based temperature dependent food grade adhesive that can be applied to bakery products made of dough so as to affix the bakery product to a bakeable paper, bakeable tray or other type of bakeable surface and to secure the bakery product on the bakeable paper, bakeable tray or other type of bakeable surface in a pre-arranged pattern through the panning, proofing, retarding, and/or baking process. The edible water-based food grade adhesive is a water-based adhesive that is absent alcohol, and includes cellulosic materials and/or plant fiber and water, and one or more water dissolvable ingredients such as starch, sweetener, gum, humectant, surfactant, stabilizer, emulsifier, thickener and preservative.

### CROSS REFERENCE TO RELATED APPLICATIONS

This application claims priority to U.S. Provisional Application No. 62/751,889, filed Oct. 29, 2018, which is incorporated herein by reference in its entirety.

### TECHNICAL FIELD

The present invention relates to adhesives, particularly to water-based adhesives, and even more particularly to edible water-based adhesives. The edible water-based temperature dependent food grade adhesive can be applied to bakery products made of dough to affix the bakery product to a bakeable paper, bakeable tray or other type of bakeable surface and to secure the bakery product on the bakeable paper, bakeable tray or other type of bakeable surface in a pre-arranged pattern from freezer to baking tray. The edible water-based food grade adhesive is a water-based adhesive that is absent alcohol, and which edible water-based food grade adhesive includes cellulosic materials and water, and one or more water-dissolvable ingredients such as starch, sweetener, gum, humectant, surfactant, stabilizer, emulsifier, thickener and preservative.

### BACKGROUND OF THE INVENTION

Traditional use of certain bakery products involves the time-consuming task of panning up products before retarding, proofing, and baking. It is time consuming to place the dough product on a baking sheet or other baking surface. Food grade adhesive are currently available; however, such adhesives can adversely affect the taste and eating quality of the product. Many of these edible adhesives are alcohol solvent-based adhesives. Additionally, currently available food grade adhesives are applied to semi-finished product and do not have to go through the typical proofing and baking process of bakery doughs.

In view of the current state of the art, there is a need for a water-based adhesive that helps bakery operators reduce preparation time needed for the dough product by providing the dough pre-placed and affixed to a bakeable paper or other type of bakeable surface, and which food grade edible adhesive does not adversely affect the quality of the food product.

### SUMMARY OF THE INVENTION

The present invention relates to an edible water-based food grade adhesive, and more particularly to an edible water-based temperature dependent food grade adhesive that can be applied to bakery products made of dough so as to affix the bakery product to a bakeable paper, bakeable tray or other type of bakeable surface and to secure the bakery product on the bakeable paper, bakeable tray or other type of bakeable surface in a pre-arranged pattern. The edible water-based food grade adhesive is formulated to secure the bakery product in a certain position on the bakeable paper, bakeable tray or other type of bakeable surface so that the bakery products are properly spaced from one another during the freezing, proofing and/or baking process. The edible water-based food grade adhesive is formulated to not impart any undesired taste to the bakery product during the freezing, proofing and/or baking process. The edible water-based food grade adhesive is formulated to effectively retain the bakery product on the bakeable paper, bakeable tray or other type of bakeable surface, but to allow the bakery product to be removed from the bakeable paper, bakeable tray or other type of bakeable surface after the baking process without damaging the bakery product. As such, the edible water-based food grade adhesive can be used from freezer to baking tray.

The present invention relates to an edible, water-based, temperature dependent, food grade adhesive comprising water, one or more cellulosic based ingredients and/or plant fiber ingredients, and one or more water dissolvable ingredients selected from the group consisting of starch, sweetener, gum, humectant, surfactant, stabilizer, emulsifier, thickener, and preservative. The present invention also includes methods for making the edible water-based temperature dependent food grade adhesive and methods for using the edible water-based temperature dependent food grade adhesive.

The methods of the present invention also include methods for shipping and then retarding, proofing and/or baking a bakery product using the edible water-based food grade temperature dependent adhesive, as well as methods for using the edible water-based temperature dependent food grade adhesive on a baking sheet, baking tray or baking surface to secure a bakery product in position on the baking sheet, baking tray or baking surface.

### DETAILED DESCRIPTION

The edible water-based food grade adhesive of the present invention is a water-based adhesive that is absent alcohol, and which edible water-based food grade adhesive includes cellulosic materials (e.g., hydroxy propyl methyl cellulose, methyl cellulose, ethyl cellulose, etc.). The edible water-based food grade adhesive has good water binding properties, good moisture retaining properties, exhibits easy release of dough products, has emulsification, and does not impart undesired taste to the product.

The edible water-based food grade adhesive does not require heat prior to use, has the desired adhesiveness and load carrying properties once frozen, and imparts no extraneous tastes, texture, odors, or undesirable visual effects to the bakery product.

The edible, water-based, food grade adhesive can be applied to bakery products made of dough so as to affix the bakery product to a bakeable paper, bakeable tray or other type of bakeable surface and to secure the bakery product on the bakeable paper, bakeable tray or other type of bakeable surface in a pre-arranged pattern. The edible water-based food grade adhesive is formulated to secure the bakery product in a certain position on the bakeable paper, bakeable tray or other type of bakeable surface so that the bakery products are properly spaced from one another during the freezing, proofing and/or baking process and is formulated to effectively retain the bakery product on the bakeable paper, bakeable tray or other type of bakeable surface, but to allow the bakery product to be removed from the bakeable paper, bakeable tray or other type of bakeable surface after the baking process without damaging the bakery product.

The edible, water-based, food grade can be temperature dependent. At room temperature (e.g., 70-80° F.), the edible water-based food grade adhesive of the present invention is in a non-solid form and exhibits only minimal adhesive properties when used with a baking product. As such, the edible water-based food grade adhesive of the present invention can be easily applied to a baking sheet, tray or the like at room temperature since the edible water-based food grade adhesive of the present invention is not in solid form, and a bakery product easily be positioned on the baking sheet, tray or the like and edible water-based food grade adhesive of the present invention will at room temperature. The edible water-based food grade adhesive of the present invention is formulated to set and/or freeze at temperatures below 35° F., and typically below 30° F., and more typically at or below about 28° F. When the edible water-based food grade adhesive of the present invention sets and/or freezes, the edible water-based food grade adhesive of the present invention maintains the bakery product on a cooking sheet, tray or the like, and prevents the bakery product from moving on the cooking sheet, tray or the like. The edible water-based food grade adhesive of the present invention is formulated to not degrade or otherwise lose its adhesive properties when set or frozen. The edible water-based food grade adhesive of the present invention is also formulated to not degrade when removed from a freezer and placed in an environment (e.g., refrigerator, retarder, etc.) at refrigerated temperatures (e.g., 33-45° F.). The edible water-based food grade adhesive of the present invention is also formulated to not degrade when removed from a freezer and placed in an environment (e.g., proofing, etc.) at refrigerated or room temperatures or proofing temperatures (e.g., 60-95° F.). As such, the edible water-based food grade adhesive of the present invention can partially or fully maintain its adhesive properties from the time the bakery product is removed from the freezer to the time the bakery product is introduced in a baking oven. During the baking process when the temperatures exceed 250° F., the edible water-based food grade adhesive of the present invention is in a liquid or semi-liquid state and allows the bakery product to be easily removed from the baking sheet, tray or the like. During the baking process, at least a portion of the edible water-based food grade adhesive of the present invention can be absorbed into the bakery product. The edible water-based food grade adhesive imparts no extraneous tastes, texture, odors, or undesirable visual effects to the bakery product.

In one non-limiting aspect of the invention the edible water-based food grade adhesive includes water, one or more cellulosic based ingredients as a base material, and one or more water-dissolvable ingredients such as starch, sweetener, gum, humectant, surfactant, stabilizer, emulsifier, thickener, and preservative.

The water content of the edible water-based food grade adhesive is generally 75-98.9 wt. % (and all values and ranges there between), typically 85-96 wt. %, and more typically 90-95 wt. %. The water content of the edible water-based food grade adhesive is the largest weight percent component of the edible water-based food grade adhesive.

The cellulosic based ingredient content of the edible water-based food grade adhesive is generally about 0.5-10 wt. % (and all values and ranges there between), typically about 0.75-8 wt. %, more typically about 1-8 wt. %, and even more typically about 1-5 wt. %. The cellulosic based ingredient in the edible water-based food grade adhesive functions as a thickening agent, increases the tensile strength of the edible water-based food grade adhesive, and/or enhances the adhesion and improves the bonding strength of the edible water-based food grade adhesive. Non-limiting examples of the cellulosic based ingredient include Hydroxy Propyl Methyl Cellulose (HPMC), Hydroxy Propyl Cellulose (HPC), and Methyl Cellulose (MC). It has been found that a portion of the cellulosic based ingredient can be substituted for a plant fiber (e.g., citrus fiber, etc.). When both cellulosic based ingredient and plant fiber are included in the edible water-based food grade adhesive, the content of both cellulosic based ingredient and plant fiber is generally about 0.5-10 wt. % (and all values and ranges there between). When both cellulosic based ingredient and plant fiber are included in the edible water-based food grade adhesive the weight ratio of the cellulosic based ingredient to the plant fiber is about 1:0.1 to 1:2 (and all values and ranges there between), and typically about 1:0.5 to 1:1.1, and even more typically about 1:1. The cellulosic based ingredient content of the edible water-based food grade adhesive or the cellulosic based ingredient plus plant fiber content of the edible water-based food grade adhesive is typically the second largest weight percent component of the edible water-based food grade adhesive.

The edible water-based food grade adhesive can optionally include a humectant (e.g., glycerin, etc.) in an amount of about 0.05-2 wt. % (and all values and ranges there between), and typically about 0.2-0.7 wt. %. The humectant, when used, functions to control viscosity and/or texture of the edible water-based food grade adhesive. The humectants can also add bulk, improve moisture retention, reduce water activity, improve softness and/or function as a preservative in the edible water-based food grade adhesive.

The edible water-based food grade adhesive can optionally include a sweetener (e.g., sugar, corn syrup, HFCS, maltodextrin, etc.) in an amount of about 0.1-10 wt. % (and all values and ranges there between), and typically about 0.5-3 wt. %. The sweetener, when used, functions as a moisture conditioner and/or crystallization inhibitor for the edible water-based food grade adhesive.

The edible water-based food grade adhesive can optionally include a starch (e.g., modified starch, corn starch, instant starch, etc.) in an amount of about 0.1-10 wt. % (and all values and ranges there between), and typically about 0.5-3 wt. %. The starch, when used, functions to improve the viscosity of the edible water-based food grade adhesive. The starch can also improve the water binding features on the edible water-based food grade adhesive. Generally, the starch is a modified starch (e.g., modified corn starch, etc.); however, this is not required.

The edible water-based food grade adhesive can optionally include a surfactant and/or emulsifier (e.g., polysorbate 80, sorbitan monostearate, sorbitan tristearate, sorbitan monooleate, polyoxyethylene monolaurate, polyoxyethylene stearate, glycerol esters, etc.) in an amount of about 0.05-5 wt. % (and all values and ranges there between), typically about 0.05-2 wt. %, and more typically about 0.2-0.7 wt. %.

The edible water-based food grade adhesive can optionally include a gum (e.g., guar gum, locust bean gum, xanthan gum, gellan, gum karaya, gum tragacanth, gum arabic, etc.) in an amount of about 0.05-3 wt. % (and all values and ranges there between), and typically 0.08-0.4 wt. %. The gum, when used, functions as a thickening agent.

Other optional ingredients that can be included in the edible water-based food grade adhesive include, but are not limited to, acidulants (e.g., citric acid, anhydrous citric acid, etc.), preservatives (e.g., potassium sorbate, sorbic acid, benzoic acid, propionic acids or their salts, alkyl esters of p-hydroxy-benzoic acid, etc.), thickeners, and/or colorants.

Non-limiting examples of formulations of the edible water-based food grade adhesive are as follows:

### Example 1

Hydroxy Propyl Methyl Cellulose (HPMC): 1-8 wt. %

Glycerin or glycerol: 0.05-2 wt. %

Polysorbate 80: 0.05-2 wt. %

Water: 88-98.9 wt. %

### Example 2

Hydroxy Propyl Cellulose (HPC): 0.5-3 wt. %

Corn syrup solids: 0.5-3 wt. %

Corn starch: 0.5-3 wt. %

Citrus fiber: 0.5-3 wt. %

Water: 88-98 wt. %

### Example 3

Hydroxy Propyl Cellulose (HPC): 1-8 wt. %

Glycerin or glycerol: 0.05-2 wt. %

Polysorbate 80: 0.05-2 wt. %

Water: 88-98.9 wt. %

### Example 4

Methyl Cellulose (MC): 1-8 wt. %

Glycerin: 0.05-2 wt. %

Polysorbate 80: 0.05-2 wt. %

Water: 88-98.9 wt. %

### Example 5

Hydroxy Propyl Methyl Cellulose (HPMC): 5-7 wt. %

Glycerin or glycerol: 0.1-0.5 wt. %

Polysorbate 80: 0.1-0.5 wt. %

Water: 92-94.8 wt. %

### Example 6

Hydroxy Propyl Cellulose (HPC): 1-3 wt. %

Corn syrup solids: 1-3 wt. %

Modified starch: 1-3 wt. %

Citrus fiber: 1-3 wt. %

Water: 88-96 wt. %

In Examples 2, 3 and 6, the edible water-based food grade adhesive of the present invention can be formed of hydrocolloid (e.g., Hydroxy Propyl Methyl Cellulose, etc.), starch (e.g., modified corn starch, modified instant starch, etc.), fiber material (e.g., citrus fiber, etc.), sweetener (e.g., corn syrup solids, etc.), and water. The ingredients were mixed in a mixer initially at slow rpm (30-50 rpm) for 1-10 minutes (e.g., 5 minutes) until the ingredients were all dissolved. The mixing was then stopped, and the mixture was then stirred to ensure that any of the left-over ingredients which were not mixed were now mixed in the mixture. Thereafter, the mixture was again mixed at a stirring speed of 80-100 rpm for about 4-20 minutes (e.g., 10 minutes) at a temperature of 70-150° F. (e.g., 120° F.). Thereafter, the mixture (i.e., edible water-based food grade adhesive) was transferred into a container and stored in the refrigerator for about 4-10 hours (e.g., 8 hours) until it became a homogeneous solution. The viscosity of the edible water-based food grade adhesive was about 600-1800 cP at 77° F. and the edible water-based food grade adhesive could be stored in refrigerated conditions for at least two months without any adverse effects to the edible water-based food grade adhesive.

In Examples 1, 4 and 5, the edible water-based food grade adhesive can also be formed of hydrocolloid (e.g., hydroxy propyl methyl cellulose, Methyl Cellulose, etc.) water, glycerol and polysorbate 80. The hydrocolloid is first dissolved in heated water (e.g., 100-1500 F) with agitation (e.g., about 60-80 rpm). Once dissolved, the polysorbate 80 and glycerol are added. After about 5-20 minutes (e.g., 15 minutes) of mixing at a temperature of 70-150° F. (e.g., 120° F.), the temperature of the mixture is reduced. Once the mixture (i.e., edible water-based food grade adhesive) reached room temperature (e.g., 65-80° F.), the edible water-based food grade adhesive was ready for use. The viscosity of the edible water-based food grade adhesive was about 600-1800 cP at 77° F. and the edible water-based food grade adhesive could be stored in refrigerated conditions for at least two months without any adverse effects to the edible water-based food grade adhesive.

One of the significant differences between the edible water-based food grade adhesive of the present invention and prior art adhesives is that only water as a solvent is being used without any alcohol-based solvent, and that the adhesive of the present invention is temperature dependent. Furthermore, the adhesive of the present invention can be applied to a raw product which needs further processing (e.g., freezing for 15-20 minutes to bond between the adhesive and the product which is then subjected to retarding proofing and baking, etc.), whereas the prior art adhesive must be applied to the final finished food product.

The edible water-based food grade adhesive can be applied to foods by methods including, but not limited to, spraying, brushing, dipping or ladling. As such, the edible water-based food grade adhesive can be first applied to the bakery product, and then the bakery product can be placed on a baking sheet, tray, or the like to secure the bakery product on the baking sheet, tray, or the like. Alternatively or additionally, the edible water-based food grade adhesive can be applied to a baking sheet, tray, or the like, and the bakery product can then be placed on the edible water-based food grade adhesive can be applied to secure the bakery product on the baking sheet, tray, or the like. After the bakery product is positioned on the baking sheet, tray, or the like, the baking sheet, tray, or the like can be placed in a freezer to as to cause the edible water-based food grade adhesive to set and thereby secure the bakery product to the baking sheet, tray, or the like. In a non-limiting embodiment, the edible water-based food grade adhesive can take a few minutes to set in temperatures below 28° F. (e.g., 10-60 minutes, 20-23 minutes, etc.).

In one non-limiting method of use, the edible water-based food grade adhesive of the present invention is first applied to a baking sheet by a dispensing device. Generally, the amount of edible water-based food grade adhesive that is applied to the baking sheet for each bakery product is sufficient to cover at least 40% of the bottom surface of the bakery product that overlies the baking sheet, typically about 50-100% of the bottom surface of the bakery product that overlies the baking sheet, more typically about 70-100% of the bottom surface of the bakery product that overlies the baking sheet, even more typically 80-100% of the bottom surface of the bakery product that overlies the baking sheet, and yet even more typically 90-100% of the bottom surface of the bakery product that overlies the baking sheet. As can be appreciated, the edible water-based food grade adhesive can be applied to the complete or substantially complete top surface of the baking sheet (e.g., edible water-based food grade adhesive applied to 80-100% of the top surface of the baking sheet, edible water-based food grade adhesive applied to 90-100% of the top surface of the baking sheet).

After, the edible water-based food grade adhesive that is applied to the baking sheet, and the bakery product is placed on the baking sheet, the baking sheet containing the bakery product is placed in the freezer for at least about 20 minutes (e.g., 20-30 minutes) so that the edible water-based food grade adhesive freezes (and also optionally the bakery products freezes during this time period). Thereafter, the bakery sheet can be placed in the cases to then stored or shipped to a customer. In one non-limiting arrangement, once the dough of the bakery product, the edible water-based food grade adhesive, and the baking paper have been in the freezer for at least about 20 minutes, the edible water-based food grade adhesive has bonded the bakery product to the baking paper. When the bakery sheets are shipped to a the customer's facility while maintained in a frozen temperature environment, and thereafter the baking sheets that include the bakery products are removed from the shipping case, the customer can simply take the baking sheet that has the bakery products adhesive connected to the top surface of the baking sheet and subject the dough of the bakery product on the baking sheet to a process of retarding, proofing and baking. Once the bakery product has been baked, the baked bakery product can be simply removed from baking sheet since the edible water-based food grade adhesive no longer adhesive secure the bakery product to the baking sheet after the baking process. Generally, a small amount of the edible water-based food grade adhesive will be residing with the bakery product after the baking process; however, this may not always occur.

It will thus be seen that the objects set forth above, among those made apparent from the preceding description, are efficiently attained, and since certain changes may be made in the constructions set forth without departing from the spirit and scope of the invention, it is intended that all matter contained in the above description shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as the come within the scope of the present invention. It is also to be understood that the following claims are intended to cover all the generic and specific features of the intention herein described and all statements of the scope of the invention, which, as a matter of language, might be said to fall there between.

We claim:

1. An edible, water-based, temperature dependent, food grade adhesive comprising water, one or more cellulosic based ingredients and/or plant fiber ingredients, and one or more water dissolvable ingredients selected from the group consisting of starch, sweetener, gum, humectant, surfactant, stabilizer, emulsifier, thickener, and preservative.

2. The edible water-based temperature dependent food grade adhesive of claim 1, comprising 75-98 wt. % water, and 0.5-10 wt. % cellulosic based ingredient and/or plant fiber ingredient.

3. The edible water-based temperature dependent food grade adhesive of claim 1, further comprising 0.05-5 wt. % humectant.

4. The edible water-based temperature dependent food grade adhesive of claim 1, comprising 0.1-10 wt. % sweetener.

5. The edible water-based temperature dependent food grade adhesive of claim 1 comprising 0.1-10 wt. % starch.

6. The edible water-based temperature dependent food grade adhesive of claim 1 comprising 0.05-5 wt. % surfactant and/or emulsifier.

7. The edible water-based temperature dependent food grade adhesive of claim 1 comprising 0.05-3 wt. % gum.

8. The edible water-based temperature dependent food grade adhesive of claim 1 further comprising one or more components selected from the group consisting of acidulants, thickeners, humectant, and/or colorants.

9. The edible water-based temperature dependent food grade adhesive of claim 1 comprising by weight percent:
a. Hydroxy Propyl Methyl Cellulose (HPMC): 1-8;
b. Glycerin: 0.05-2;
c. Polysorbate 80: 0.05-2; and
d. Water: 88-98.9.

10. The edible water-based temperature dependent food grade adhesive of claim 1 comprising by weight percent:
a. Hydroxy Propyl Cellulose (HPC): 0.5-3;
b. Corn syrup solids: 0.5-3;
c. Corn starch, instant: 0.5-3;
d. Citrus fiber: 0.5-3; and
e. Water: 88-98.
f.

11. The edible water-based temperature dependent food grade adhesive of claim 1, comprising by weight percent:
a. Hydroxy Propyl Cellulose (HPC): 1-8;
b. Glycerin: 0.05-2;
c. Polysorbate 80: 0.05-2; and
d. Water: 88-98.9.

12. The edible water-based temperature dependent food grade adhesive of claim 1, comprising by weight percent:
a. Hydroxy Methyl Cellulose (HPMC): 1-8;
b. Glycerin: 0.05-2;
c. Polysorbate 80: 0.05-2; and
d. Water: 88-98.9.

13. The edible water-based temperature dependent food grade adhesive of claim 1, comprising by weight percent:
a. Hydroxy Propyl Methyl Cellulose (HPMC): 5-7;
b. Glycerin or glycerol: 0.1-0.5;
c. Polysorbate 80: 0.1-0.5; and
d. Water: 92-94.8.

14. The edible water-based temperature dependent food grade adhesive of claim 1, comprising by weight percent:
a. Hydroxy Propyl Cellulose (HPC): 1-3;
b. Corn syrup solids: 1-3;
c. Modified starch: 1-3;
d. Citrus fiber: 1-3; and
e. Water: 88-96.

15. The edible, water-based, food grade, temperature dependent, adhesive of claim 1, wherein the adhesive is applied to bakery products made of dough so as to affix the bakery product to a bakeable paper, bakeable tray or other type of bakeable surface and to secure the bakery product on the bakeable paper, bakeable tray or other type of bakeable surface in a pre-arranged pattern.

16. The edible water-based food grade adhesive of claim 15, wherein the adhesive is formulated to secure the bakery product in a certain position on the bakeable paper, bakeable tray or other type of bakeable surface so that the bakery products are properly spaced from one another during the freezing, proofing and/or baking process.

17. The edible water-based food grade adhesive of claim 16 wherein the adhesive is formulated to effectively retain the bakery product on the bakeable paper, bakeable tray or other type of bakeable surface, but to allow the bakery product to be removed from the bakeable paper, bakeable tray or other type of bakeable surface after the baking process without damaging the bakery product.

18. The edible water-based food grade adhesive of claim 1 wherein the adhesive imparts no extraneous tastes, texture, odors, or undesirable visual effects to the bakery product.

19. The edible water-based food grade adhesive of claim 17 wherein the adhesive is in a non-solid form and exhibits only minimal adhesive properties when used with a baking product at room temperature of 70-80° F.

20. The edible water-based food grade adhesive of claim 19 wherein the adhesive is formulated to set or freeze at temperatures below 35° F. and wherein after the adhesive is set the adhesive does not degrade or otherwise lose its adhesive properties when
a. at freezing temperatures of below 28° F.;
b. at refrigerated temperatures of 33-45° F.; or
c. at proofing temperatures of 60-95° F.

21. The edible water-based food grade adhesive of claim 20, wherein the adhesive is in a liquid or semi-liquid state when the temperature exceeds 250° F., and wherein the liquid or semi-liquid state allows the bakery product to be easily removed from the baking sheet, baking tray or the baking surface.

22. A method for using the edible water-based temperature dependent food grade adhesive of claim 1.

23. A method for making then edible water-based temperature dependent food grade adhesive of claim 1.

24. The method of claim 23 wherein
a. a hydrocolloid is dissolved in water heated to a temperature of between 100-1500 F using agitation of between 60-80 rpm to produce a mixture;
b. then polysorbate and glycerol are added to the mixture and mixed for between 5-20 minutes at a temperature of 70-150° F.; and
c. the temperature of the mixture is then reduced to a room temperature of 65-80° F.

25. The method of claim 23 wherein
a. a hydrocolloid, a starch, fiber material, sweetener and water are first mixed at 30-50 rpm for 1-10 minutes until dissolved into a mixture;
b. mixing is then stopped, and the mixture is stirred to ensure that any ingredients which are not in the mixture are stirred into the mixture; and
c. the mixture is mixed again at a speed of 80-100 rpm for between 4-20 minutes at a temperature of 70-150° F.

26. A method for shipping and then retarding, proofing and/or baking a bakery product using the edible water-based food grade temperature dependent adhesive of claim 1.

27. A method for using the edible water-based temperature dependent food grade adhesive of claim 1 on a baking sheet, baking tray or baking surface to secure a bakery product in position on the baking sheet, baking tray or baking surface.
